(19) United States
(12) Patent Application Publication
(10) Pub. No.: US 2010/0141600 A1
(43) Pub. Date: Jun. 10, 2010

(54) TOUCH SCREEN

(75) Inventors: Sung-Soo Park, Seongnam-si (KR); Dong-Kyoon Han, Seongnam-si (KR); Yu-Sheop Lee, Suwon-si (KR); Sun-Tae Jung, Yongin-si (KR)

Correspondence Address: THE FARRELL LAW FIRM, LLP, 290 Broadhollow Road, Suite 210E, Melville, NY, 11747, US

(73) Assignee: Samsung Elecironics Co., Ltd., Suwon-si (KR)

(21) Appl. No.: 12/633,422

(22) Filed: Dec. 8, 2009

(30) Foreign Application Priority Data
Dec. 8, 2008 (KR) 10-2008-0124060

(51) Int. Cl. G06F 3/041

(52) U.S. Cl. 345/173

(57) ABSTRACT

A touch screen is provided, in which a first layer of a transparent electrode is spaced from a second layer of a transparent electrode and a refraction index matching layer is interposed between the first and second layers of the transparent electrodes.

### PRIORITY

This application claims priority under 35 U.S.C. §119(a) to a Korean Patent Application filed in the Korean Intellectual Property Office on Dec. 8, 2008 and assigned Serial No. 10-2008-0124060, the entire disclosure of which is hereby incorporated by reference.

### BACKGROUND OF THE INVENTION

1. Field of the Invention

The present invention generally relates to an input device. More particularly, the present invention relates to an input device such as a touch screen.

2. Description of the Related Art

Many input devices such as a keyboard, a mouse, a pen mouse, etc. have been used to enter a variety of information or user selections. Among them, a touch screen finds its diverse applications in many devices because it functions as an input device as well as provides information to a user.

There are largely three types of touch screens: resistive touch screens, capacitive touch screens, and optical touch screens. In a resistive touch screen with dot spacers inserted between layers of transparent electrodes, information is input through electrical contact points formed by corresponding pressure applied by a user. A capacitive touch screen senses a capacitive variation that happens when a user touches its upper surface.

A conventional resistive touch screen may include layers of transparent electrodes with electrode patterns formed thereon, dot spacers between the layers of transparent electrodes to space them from each other, a protection film on the upper layer of transparent electrodes, and an image display device under the lower layer of transparent electrodes. An organic liquid crystal panel can be used as the image display device.

The spacers are separated from one another, between the upper and lower transparent electrode layers, by a predetermined gap, so that the transparent electrodes are kept separated by a predetermined spacing. The spacers also provide a restoring force to the transparent electrodes so that the electrodes go back to their original separated state after they are brought into contact by pressure applied onto the touch screen by the user.

However, the existence of an air gap between the layers of transparent electrodes separated by the spacers causes loss due to light reflection from the boundary between the air and the transparent electrodes in the resistive touch screen. Therefore, the resistive touch screen has a decreased transmittance rate because of the light loss. Especially under a bright external light source, reflection from the air gap makes it difficult for the user to recognize an image displayed on the touch screen.

### SUMMARY OF THE INVENTION

An aspect of embodiments of the present invention is to address at least the problems and/or disadvantages set forth above and to provide at least the advantages described below. Accordingly, an aspect of embodiments of the present invention is to provide a touch screen for minimizing reflection loss in an air gap.

In accordance with an aspect of embodiments of the present invention, there is provided a touch screen in which a first layer of transparent electrodes is spaced from a second layer of transparent electrode and a refraction index matching layer is interposed between the first and second layers of transparent electrodes.

### BRIEF DESCRIPTION OF THE DRAWINGS

The above and other objects, features and advantages of certain embodiments of the present invention will be more apparent from the following detailed description taken in conjunction with the accompanying drawings, in which:

FIG. 1 is a sectional view of a touch screen according to an embodiment of the present invention.

### DETAILED DESCRIPTION OF EXEMPLARY EMBODIMENTS

The matters defined in the description such as a detailed construction and elements are provided to assist in a comprehensive understanding of embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

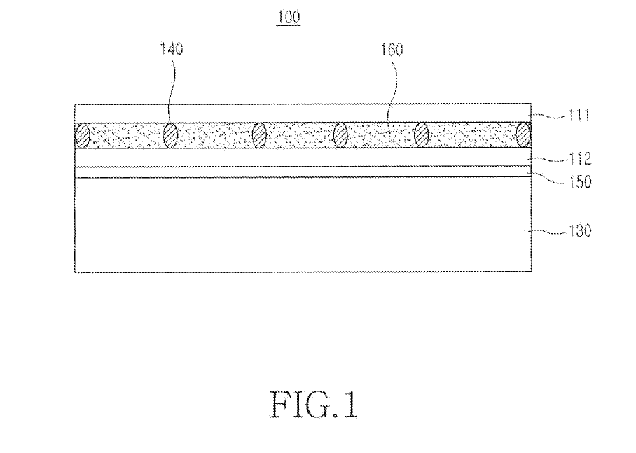

FIG. 1 is a sectional view of a touch screen according to an embodiment of the present invention.

Referring to FIG. 1, the touch screen of the present invention includes first and second layers of transparent electrodes 111 and 112 spaced apart from each other, spacers 140 between the first and second layers of transparent electrodes 111 and 112 to separate the first layer of the transparent electrodes 111 from the second layer of the transparent electrodes 112, an image display device 130, an adhesive layer 150 for adhering the image display device 130 to the second layer of the transparent electrodes 112, and a refraction index matching layer 160 filled between the spacers 140.

The image display device 130 may be configured with a Liquid Crystal Display (LCD). The image display device 130 may provide a user with visual information in various forms such as text or image information like moving pictures and still images. Information provided to the image display device 130 may be provided to the user through the first and second layers of the transparent electrodes 111 and 112. The adhesive layer 150 may be replaced by an air gap when needed.

The image display device 130 provides image information via light and the image information should be transmitted through the first and second layers of the transparent electrodes 111 and 112 and the refraction index matching layer 160.

Water, glycol, or ethanol having a refraction index greater than 1, or a mixture of at least two of water, glycol, and ethanol may be used for the refraction index matching layer 160. The refraction index matching layer 160 may also be formed of a chloride such as calcium chloride or magnesium chloride, or an ionic compound. That is, the refraction index matching layer 160 may be formed of a material with a high electric resistance, such as a water added with an antifreezing solution, a mixture of water and glycerin, or the like. Conditions including a melting point may be controlled by adjusting the amounts of the materials.

A mixture of materials with different refraction indexes or a nanoparticle-doped liquid may be used for the refraction index matching layer 160.

A conventional touch screen having an air gap with a refraction index of 1 between the first and second layers of the transparent electrodes 111 and 112 suffers about 5% of light reflection at the boundaries between the first layer of the transparent electrodes 111 and the air gap and between the second layer of the transparent electrodes 112 and the air gap, due to refraction index differences. In contrast, since the refraction index matching layer 160 with a refraction index greater than 1 is filled between the first and second layers of the transparent electrodes 111 and 112, the refraction index differences between the refraction index matching layer 160 and the first and second layers of the transparent electrodes 111 and 112 are decreased and as a result, light reflection from the boundaries between the refraction index matching layer 160 and the first and second layers of the transparent electrodes 111 and 112 is reduced according to the present invention.

In the case where the first and second layers of the transparent electrodes 111 and 112 are formed of Polyethylene Terephthalate (PET) having a refraction index of 1.575, for example, the conventional touch screen having an air gap between the layers of the transparent electrodes 111 and 112 may suffer from about 10% of light loss between the air gap and the layers of the transparent electrodes 111 and 112. On the other hand, the touch screen 100 of the present invention, which has the refraction index matching layer 160 filled between the layers of the transparent electrodes 111 and 112 can reduce light reflection from the boundaries between the refraction index matching layer 160 and the layers of the transparent electrodes 111 and 112 to about 1.4%. The comparison is made, taking an example where the touch screen 100 has a material of a refraction index of 1.36 filled between the first and second layers of the transparent electrodes 111 and 112 with a refraction index of 1.575.

As is apparent from the above description, since a refraction index matching layer having a refraction index not much different from those of the layers of the transparent electrodes, compared to an air gap between the layers of the transparent electrodes, is filled between the layers of the transparent electrodes, light reflection caused by a refraction index difference is minimized between the layers of electrodes and the refraction index matching layer. The resulting minimization of the reflection rate of a touch screen reduces external light reflection and increases the brightness of images provided to a user.

That is, as the refraction index difference between the transparent electrode layers is decreased, the loss of light intensity of image information provided to the user can be minimized and the reflection of external light can be reduced. Therefore, the visibility of images displayed on the touch screen can be improved.

While the invention has been shown and described with reference to certain exemplary embodiments of the present invention thereof, it will be understood by those skilled in the art that various changes in form and details may be made therein without departing from the spirit and scope of the present invention as defined by the appended claims and their equivalents.

What is claimed is:

1. A touch screen, comprising:
a first layer of a transparent electrode;
a second layer of a transparent electrode spaced from the first layer of the transparent electrode; and
a refraction index matching layer interposed between the first and second layers of the transparent electrodes.

2. The touch screen of claim 1, further comprising an image display device located below the second layer of the transparent electrodes.

3. The touch screen of claim 2, wherein the refraction index matching layer is formed of a material with a refraction index equal to or greater than 1.

4. The touch screen of claim 3, wherein the refraction index matching layer is formed of a liquid having a refraction index ranging from 1.2 to 1.7.

5. The touch screen of claim 4, wherein the refraction index matching layer is formed of at least one of water, glycol, and ethanol.

6. The touch screen of claim 3, wherein the refraction index matching layer is formed of a carbon compound.

7. The touch screen of claim 3, wherein the refraction index matching layer is formed of a chloride.

8. The touch screen of claim 3, wherein the refraction index matching layer is formed of an ionic compound.
